(19) United States
(12) Patent Application Publication
(10) Pub. No.: US 2020/0047207 A1
(43) Pub. Date: Feb. 13, 2020

(54) METHOD AND PAINTING SYSTEM FOR PAINTING A WORKPIECE BY MEANS OF AN ATOMIZER

(71) Applicant: EISENMANN SE, Söblingen (DE)

(72) Inventor: Oliver MAIER, Herrenberg (DE)

(21) Appl. No.: 16/485,956

(22) PCT Filed: Feb. 8, 2018
(86) PCT No.: PCT/EP2018/053152

§ 371 Date: Aug. 14, 2019

(30) Foreign Application Priority Data
Feb. 15, 2017 (DE) 10 2017 103 007.7

(51) Int. Cl. B05B 12/08; B05B 13/04; B05D 1/04; B05B 5/025; B05B 12/00

(52) U.S. Cl. CPC B05B 12/082; B05B 13/0452; B05B 12/004; B05B 5/025; B05D 1/04

(57) ABSTRACT

A method for painting a workpiece, wherein an application device having an atomizer directs a spray jet onto the workpiece, the spray jet geometry of which is modifiable by the application device. A camera captures an image of the spray jet. An image processing device detects deviations between the spray jet recorded on the image and a target spray jet. A control device controls the application device as a factor of the deviations detected by the image processing device.

### BACKGROUND OF THE INVENTION

### 1. Field of the Invention

The invention relates to a method and a painting system for painting a workpiece by means of an atomizer. In particular, the invention relates the problem of optimizing the spray jet produced by the atomizer, with the objective of improving the quality of painting and minimizing the quantity of paint consumed and the overspray.

### 2. Description of the Prior Art

Normally, application device, which have a robot and an atomizer carried by a movable arm of the robot, are used for automatic painting of vehicle bodies, housing parts or other workpieces. The atomizer produces a spray jet of paint that is directed onto the workpiece. By means of the robot, the atomizer is guided over the workpiece, along a predefined path, such that the spray jet sweeps over the parts of the workpiece to be painted and coats them uniformly with paint.

Known in the prior art are hydraulic atomizers, in which the paint is forced at high pressure through a nozzle. During emergence from the nozzle, turbulent flows a produced, as a result of which the paint breaks down into individual small droplets. In the case of pneumatic atomizers, the paint is accelerated by means of a propellant gas and forced out of a nozzle. Also known are atomizers in which the paint is accelerated by means of an electrical field, in order ultimately to emerge from a nozzle.

The most common are rotary atomizers, in which the paint is directed onto a very rapidly rotating disk, also often referred to as a bell cup. Owing to the centrifugal force acting in this case, the paint is accelerated outward and separates at the edge of the bell cup. As a result, the paint film is broken down into fine droplets.

Since the paint is spun away radially outward, pressurized guiding air additionally emerges at the atomizer. This air entrains the paint particles and deflects them such that a spray jet, directed axially forward, is formed. Guiding air in this case means any air flow that emerges from the atomizer. In the case of some atomizers, differing air flows emerge from the atomizer, which can be influenced independently of each other by means of special rings or caps.

Usually, despite the use of guiding air for jet formation, in the case of painting by means of atomizers not all paint particles are deposited on the workpiece. The portion of the paint that is not permanently deposited on the workpiece is referred to as overspray. Usually, the painting operation takes place in a painting cabin, in which an air current is generated. The air current entrains the overspray and directs it to a separating device.

Since the generation of the air current and the separation process result in high costs, and only a portion of the overspray can be recovered in the separation process, minimization of the overspray represents an important objective in the automatic painting of workpieces by means of atomizers.

In addition to the use of guiding air for jet formation, frequently the paint is electrostatically charged prior to atomization, in order to minimize the overspray. By application of a voltage to the workpiece, it can be achieved that the latter electrostatically attracts the electrically charged paint particles. In this way, a greater proportion of the paint particles remains adhering to the workpiece.

In the automatic painting of workpieces, there is the problem that, in the defining of the relative movement and the distance between the atomizer and the workpiece, a defined spray jet geometry is assumed. The spray jet geometry can be parameterized by a plurality of features. These include, in particular, the width of the spray jet at a defined distance from the atomizer, the maximum angle of the spray jet upon emergence from the atomizer, with respect to a longitudinal axis of the atomizer, the density distribution of the spray jet, the outer contour of the spray jet, and variations of one of the aforementioned features over time. If the spray jet geometry changes after a paint change, between successive painting operations with the same paint, or also within a single painting operation, this can result in the occurrence of painting defects. Such a painting defect normally manifests itself in that the paint has not been applied uniformly, with the desired thickness, to the workpiece. Frequently, in such a case it is necessary for the workpiece to be expensively reworked; under certain circumstances, for cost reasons it is cheaper for the workpiece to be separated out.

Hitherto, it has been sought to ensure maintenance of a desired spray jet geometry in that an experienced skilled operator visually checks the geometry of the spray jet upon each paint change, or also between individual painting operations. For this purpose, the skilled operator directs the spray jet onto a test object under favorable light conditions, and varies the control parameters of the application device until the desired spray jet geometry is obtained. However, this visual checking requires a lot of experience, requires a relatively large amount of time, and does not always provide reproducible results. Moreover, during the checking process paint is consumed and overspray is produced.

### SUMMARY OF THE INVENTION

The object of the invention is to specify a method and a painting system for painting workpieces by which a desired geometry of the spray jet can be set particularly rapidly.

In respect of the method, this object is achieved by a method for painting a workpiece, which comprises the following steps:

a) by means of an atomizer, an application device directs onto the workpiece a spray jet, the spray jet geometry of which can be altered by the application device;

b) a camera captures an image of the spray jet;

c) an image processing device detects deviations between the spray jet captured on the image and a reference spray jet;

d) a control device controls the application device in dependence on the deviations detected by the image processing device.

The invention is based on the consideration of automating the checking of the spray jet geometry performed by a skilled operator. The electronic processing of an image of a spray jet captured by a camera makes it possible to quantify features of the spray jet such that, on the basis of the information thereby obtained, the geometry of the spray jet can be approximated to the reference geometry by appropriate control of the application device. The setting of a desired spray jet geometry thus becomes accessible to a feedback control that results in a constant generation of a defined spray jet geometry that is independent of variable paint parameters.

Because such a feedback control can be performed automatically in a very short period of time, the idle times during paint changes are shortened. Specifically in modern production lines, in which paint changes are performed very frequently, a significant increase in productivity can be achieved as a result. Moreover, for the setting of the desired spray jet geometry, less paint is consumed and less overspray is produced.

Since such a feedback control can also be performed during a painting operation, or between successive painting operations with the same paint, the invention enables the quality of painting to be improved and the expense for reworking to be reduced.

Experiments have shown that, during the capture of the image of the spray jet in step b), an optical axis of the camera should be oriented at least substantially perpendicularly in relation to a longitudinal axis of the atomizer. The geometry of the spray jet can then be detected more easily, since geometric distortions are minimized. In principle, however, it is also possible for an image to be captured from an oblique perspective. However, the image analysis is then more complex because of the geometric distortions.

In this context, the longitudinal axis of the atomizer is understood to mean an axis that is in alignment with an axis of symmetry of the spray jet. In general, the longitudinal axis is an axis of symmetry of the outlet nozzle of the atomizer. In the case of rotary atomizers, the longitudinal axis is defined by the axis of rotation of the bell cup.

In principle, the image of the spray jet can be captured while the latter is directed onto the workpiece. This is generally to be preferred, particularly if feedback control of the spray jet geometry is performed during a painting operation. However, the surface of the workpiece may influence the shape of the spray jet. For this reason, at least when the spray jet geometry is checked, in the manner according to the invention, only at longer intervals, it is generally more favorable if the painting of the workpiece is interrupted during the capture of the image in step b).

During such an interruption, the atomizer may paint a test object, e.g. a plate, during the capture of the image in step b). Conditions are thereby created that come as close as possible to a real painting operation, but are nevertheless exactly reproducible. It is possible to additionally record the painted surface of the test object by means of the same or a different camera. The painting result achieved there can then also be used to evaluate particular parameters of the spray jet, e.g. the density distribution.

It is also possible to use a surface in a cleaning box as a test object. Such a cleaning box is approached by the atomizer in order to perform a cleaning operation, which is required as part of a paint change.

In order to record one of the above-mentioned features of the spray jet geometry, the image processing device may subject the captured image of the spray jet to edge filtering. Determination of the outer edge of the spray jet makes it possible to determine particularly important features of the spray jet geometry, including the width of the spray jet at a predefined distance from the atomizer, the maximum angle of the spray jet upon emergence from the atomizer, with respect to a longitudinal axis of the atomizer, and the shape of the outer contour of the spray jet.

If a plurality of images of the spray jet are captured, it is also possible to ascertain changes in these features over time. It is therefore also possible for the camera used for capturing the images to be used in a video mode, in which a plurality of images are captured per second.

If the atomizer is a rotary atomizer, in step d) the control device may alter at least one of the following control parameters of the application device: pressure of a guiding air discharged from the rotary atomizer, rotational speed of the rotary atomizer, volumetric flow and temperature of the paint supplied to the atomizer. These control parameters have a direct influence on the geometry of the spray jet, and are therefore suitable for influencing the spray jet geometry in order to minimize deviations from a reference geometry.

The invention additionally provides a painting system for painting a workpiece by means of an application device, which is configured, by means of an atomizer, to direct onto the workpiece a spray jet, the spray jet geometry of which can be altered by the application device. A camera is configured to capture an image of the spray jet. An image processing device is configured to detect deviations between the spray jet captured on the image and a reference spray jet. A control device is configured to control the application device in dependence on the deviations detected by the image processing device.

Owing to the advantages achieved with the painting system according to the invention, reference is made to the above statements concerning the method.

In order to prevent the camera from being soiled with overspray, the camera may be arranged outside of a painting cabin. Alternatively, it is possible for the camera to be arranged inside the painting cabin. A position in the upper region of the painting cabin, in which there is less overspray, is then preferred. If the camera is to be arranged in the lower region of the painting cabin, additional cleaning devices, for example an air curtain or a fluid cleaning system, may be provided to prevent the camera optics from becoming soiled with overspray. It may also be advantageous, in the case of particular applications, for the camera to be arranged on a movable arm of a robot that carries the atomizer.

### BRIEF DESCRIPTION OF THE DRAWINGS

Exemplary embodiments of the invention are explained in greater detail in the following on the basis of the drawings. There are shown in the latter:

FIG. 1 a perspective view of a painting system according to the invention, only a portion of the painting cabin being represented;

FIG. 2 a schematic representation of important components of the painting system according to the invention;

FIG. 3 a schematic representation of how a camera captures an image of a spray jet that is directed onto a test object;

FIGS. 4a to 4d an image captured by the camera, n differing stages of image processing.

### DESCRIPTION OF PREFERRED EXEMPLARY EMBODIMENTS

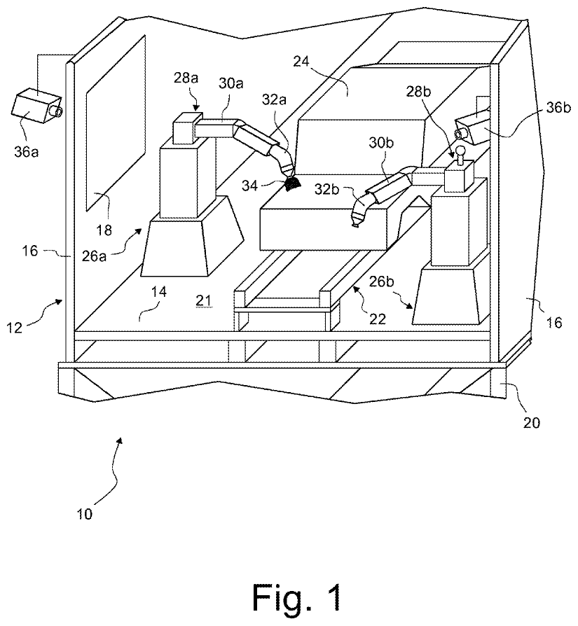

A painting system according to the invention is represented in perspective view in FIG. 1, and denoted as a whole by 10. The painting system 10 includes a fully closed painting cabin 12, of which, for greater clarity, only some parts are represented. In the exemplary embodiment represented, the painting cabin 12 comprises a floor region 14, four side walls 16, of which only two are represented in FIG. 1, and a ceiling, likewise not shown. The side wall 16 represented on the left is provided with a window 18, which affords a view into the interior 20 of the painting cabin 12. The painting cabin 12 stands on a base structure 20, as is known per se in the prior art.

In the exemplary embodiment represented, the floor region of the painting cabin 12 carries a conveying system, indicated at 22, on which workpieces—in this case vehicle bodies 24—can be conveyed along a conveyance direction. Before being painted, the vehicle bodies 24 are transferred by means of the conveying system 22 into the painting cabin 12, through rolling doors or other closable openings, and following completion of painting are transferred back out of the painting cabin 12.

Application device 26a, 26b are arranged, on both sides of the conveying system 22, in the painting cabin 12. Each application device 26a, 26b has a robot 28a and 28b, respectively, which each have a movable robot arm 30a and 30b, respectively. Each robot arm 30a, 30b carries a rotary atomizer 32a, 32b, to which liquid paint and compressed air are supplied, via lines that are not represented. The supply of paint and compressed air is part of the application device 26a, 26b, and may also be arranged, at least partly, outside of the painting cabin 12.

The paint may be, for example, a base coat that is responsible for the coloring of the body, or a clear coat that protects the previously applied base coat against UV radiation and provides the gloss of the vehicle bodies 24. The paints used differ, not only in respect of their transparency and color, but also in respect of their viscosity and surface tension. The geometry of the spray jet 34 produced by the rotary atomizers 32a, 32b therefore depends on the type of paint to be applied. Since the temperature of the paint also affects its viscosity and surface tension, the geometry of the spray jet 34, and therefore also the painting result itself, can vary when one and the same paint is applied.

For the purpose of painting the vehicle body 24, the robot arms 30a, 30b move the rotary atomizers 32a, 32b fastened therein rapidly over the vehicle bodies 24, along predefined paths. The spray jet 34 produced by the rotary atomizers 32a, 32b in this case sweeps over the surface of the vehicle body 24, at a predefined distance, such that the paint particles can be deposited thereon. In order to improve the adhesion of the paint particles, the paint particles can be electrically charged, and the vehicle body 24 grounded, as is known in the prior art.

The painting system 10 known to this extent differs from conventional systems in that the painting operation is monitored by a first camera 36a and a second camera 36b. The first camera 36a is fastened outside of the painting cabin 12, and captures images of the painting operation through the window 18. The second camera 36b is fastened inside the painting cabin 12, and may be equipped with an additional protective device (not represented) to protect against overspray. In the exemplary embodiment represented, the cameras 36a, 36b are normal cameras that capture images in the visible wavelength spectrum.

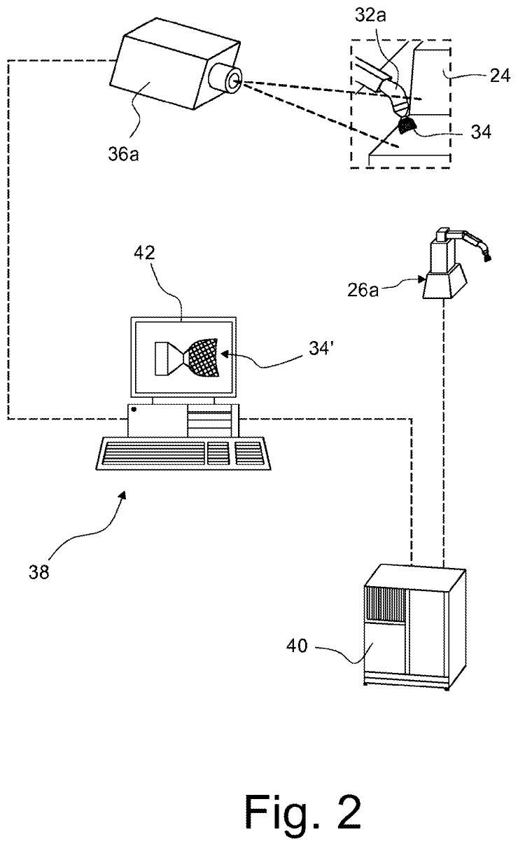

FIG. 2 shows important components of the painting system 10 according to the invention, in a schematic representation. Represented at the top is the first camera 36a, which is connected, via a signal line, to an image processing device 38, which is likewise part of the painting system 10. The image processing device 38 is connected, via a further signal line, to a control device 40 for the application device 26a. In FIG. 2, the image processing device 38 and the control device 40 are represented as separate structural units. Clearly, these means may also be spatially combined and, in particular, realized as different modules of a computer program that is executed on a microprocessor.

In FIG. 2 it is assumed that images of the spray jet 34 are captured during the ongoing painting operation—as represented at top right in FIG. 2—by the first camera 36a. These images are processed by the image processing device 38 and compared with a reference spray jet. Since the position of the robot arm 30a, and therefore the position of the rotary atomizer 36a, at each point in time is known, the perspective distortion that arises as a result of the spray jet 34 being observed obliquely can be subtracted in the image processing device 38. The result is a corrected image 34′ of the spray jet 34, as represented exemplarily in FIG. 2 on a monitor screen 42 of the image processing device 38.

The image 34′ of the spray jet 34 can then be processed with suitable image processing algorithms, and geometrically analyzed. The geometrical parameters derived therefrom are compared, in the image processing device 38, with reference parameters of a reference spray jet. If the deviations between the geometry captured by the camera 36a and the desired geometry of the spray jet exceed predefined tolerances, a control algorithm of the control device 40 calculates therefrom control commands for the application device 26a, to minimize the deviations. For this purpose, the control device 40 may act, in particular, upon the pressure with which guiding air emerges from the rotary atomizer 32a, upon the pressure, and therefore the volume, of the paint discharged from the rotary atomizer 32a, and/or upon the temperature of the paint supplied to the rotary atomizer 32a. It is additionally possible to alter the movement path of the robot arm 30a, in order thus to adjust the distance between the rotary atomizer 32a and the surface of the vehicle body 24.

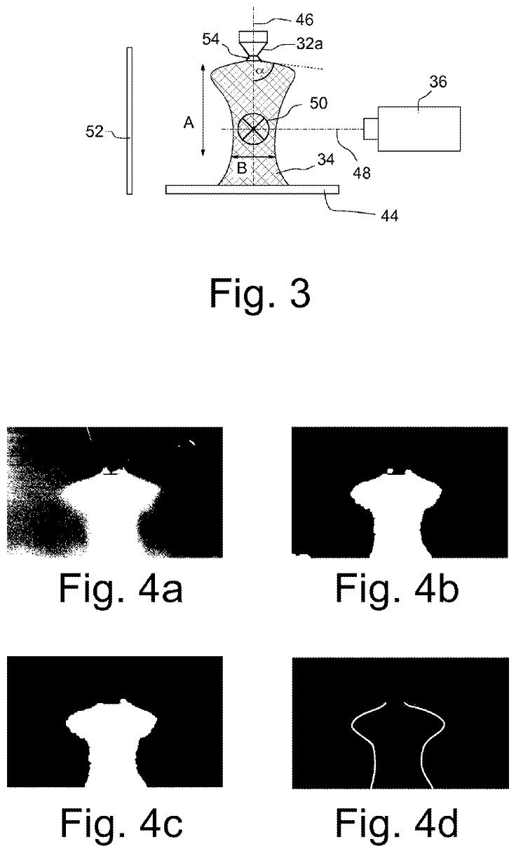

Instead of capturing the spray jet 34 while it is being directed onto the vehicle body 24, it is also possible to perform camera-assisted determination of the spray jet geometry under ore reproducible conditions, as is illustrated by FIG. 3. There, the spray jet 34 is directed onto a test object 44, which, in a simplest case, is a plate. The axis of rotation 46 of the rotary atomizer 32a in this case is oriented, by means of the robot arm 30a, such that it is perpendicular to the planar surface of the test object 44. Close to the test object 44 there is a fixedly arranged camera 36, the optical axis of which is parallel to the surface of the test object 44 and perpendicular to the axis of rotation 46 of the rotary atomizer 32a. A light source, indicated at 50, is oriented such that its main direction of emission is perpendicular both to the axis of rotation 46 and to the optical axis 48.

Experiments have shown that, under these defined conditions, the geometry of the spray jet 34 can be captured in a particularly precise manner by means of the camera 36. Owing to the illumination of the spray jet 34 by means of the light source 50, transversely in relation to the optical axis 48 of the camera 36, the paint particles are clearly discernible. The discernibility of the paint particles is enhanced if a screen 52, which is illuminated as uniformly as possible, is located on a side opposite to the camera 36.

Indicated in FIG. 3 are important geometrical features of the spray jet 34, which can be deduced from the image captured by means of the camera 36. Indicated features are the width B of the spray jet 34 at the distance a from the rotary atomizer 32a, and the opening angle α of the spray jet directly at the bell cup 54 of the rotary atomizer 32a.

FIGS. 4a to 4d show an image of the spray jet 34 in differing image processing stages. Represented in FIG. 4a is a binary image, which was obtained from the capture color image by application of a simple filter algorithm. For this purpose, the color image is first converted into a grey-scale image. Depending on whether the grey value is then above or below a predefined threshold value, a color white or black is assigned to a pixel.

In FIG. 4b, spurious pixels, which to not belong to the spray jet, are removed. For this purpose, the algorithm removes all objects whose size is below a threshold value. As a result, image noise is removed at the same time, and the outer contour of the spray jet 34 is smoothed.

A further algorithm is used to remove further objects that do not belong to the spray jet, as a result of which the image of the spray jet represented in FIG. 4c is obtained.

An edge detection algorithm is then used to obtain the contour of the spray jet, as represented in FIG. 4d. By means of algorithms that are known per se, the features of the spray jet geometry indicated in FIG. 3 can then be deduced from the outer contour of the spray jet, and compared with reference values. The reference values may be deduced, for example, from already captured images of a spray jet that has produced a good painting result for the workpiece concerned. Alternatively, the reference values may be determined from functional relationships that are available, for example, in the form of tables and based on empirical values obtained over a relatively long period of time. Such empirical values may also be included in an expert system that then outputs appropriate reference values.

After this adjustment has been performed, the robot arm 30a brings the rotary atomizer 32a back into the correct processing position, opposite the vehicle body 24. If the ascertained deviations between the captured spray jet and the reference spray jet are unacceptably large, the painting operation is continued with altered control parameters.

The painting system 10 can be controlled such that the checking of the spray jet geometry described above is performed whenever a property of the reference spray jet is to be changed. Besides its geometry, the properties of the reference spray jet also include the paint used. For this reason, the check is typically performed after each color change and after each change of tool type.

Also possible, however, is a (possibly additional) regular check, since the properties of the paint, and therefore the geometry of the spray jet, also change with temperature variations.

What is claimed is:

1. A method for painting a workpiece comprising the following steps:
a) directing a spray jet onto a workpiece using an application device having an atomizer, the spray jet geometry of which can be altered by the application device;
b) capturing an image of the spray jet using a camera;
detecting deviations between the spray jet captured on the image and a reference spray jet using an image processing device; and
d) controlling the application device with a control device in dependence on the deviations detected by the image processing device.

2. The method as claimed in claim 1, in which, during step b), an optical axis of the camera is oriented at least substantially perpendicular in relation to a longitudinal axis of the atomizer.

3. The method as claimed in claim 1, in which the painting of the workpiece is interrupted during step b).

4. The method as claimed in claim 3, in which the atomizer paints a test object during step b).

5. The method as claimed in claim 3, in which step b) is performed at least when a property of the reference spray jet is to be changed.

6. The method as claimed in claim 1, in which the image processing device determines at least one feature of the spray jet geometry, wherein the at least one feature of the spray jet is selected from the group composed of:
width of the spray jet (34) at a predefined distance (A) from the atomizer,
maximum angle of the spray jet upon emergence from the atomizer, with respect to a longitudinal axis of the atomizer,
density distribution of the spray jet,
shape of the outer contour of the spray jet, or
variations of one of the aforementioned features over time.

7. The method as claimed in any one of the preceding claims, in which the image processing device (38) subjects the captured image (34′) of the spray jet (34) to edge filtering.

8. The method as claimed in claim 1, in which, in step d), the control device alters at least one of the following control parameters of the application device:
pressure of a guiding air discharged from the atomizer,
volumetric flow of the paint supplied to the atomizer
temperature of the paint supplied to the atomizer.

9. A painting system for painting a workpiece, comprising:
an application device, which is configured by means of an atomizer to direct a spray jet onto a workpiece, the spray jet geometry of which can be altered by the application device,
a camera configured to capture an image of the spray jet,
an image processing device configured to detect deviations between the spray jet captured on the image and a reference spray jet; and
a control device configured to control the application device in dependence on the deviations detected by the image processing device.

10. The painting system as claimed in claim 9, in which the image processing device is configured to determine at least one feature of the spray jet geometry, wherein the at least one feature of the spray jet geometry is selected from the group composed of:
width of the spray jet at a predefined distance from the atomizer,
maximum angle of the spray jet upon emergence from the atomizer, with respect to a longitudinal axis of the atomizer,
density distribution of the spray jet,
shape of the outer contour of the spray jet, or
variations of one of the aforementioned features over time.

11. The painting system as claimed in claim 9, in which an optical axis of the camera is oriented at least substantially perpendicularly in relation to a longitudinal axis of the atomizer.

12. The painting system as claimed in claim 9, further comprising a painting cabin, in which the atomizer is arranged, wherein the camera is arranged outside of the painting cabin.

13. The painting system as claimed in claim 9, wherein the control device is configured to alter, in step d), at least one of the following control parameters of the application device:
pressure of a guiding air discharged from the rotary atomizer,
volumetric flow of the paint discharged from the atomizer,
temperature of the paint discharged from the atomizer.
